(19) United States
(12) Patent Application Publication
(10) Pub. No.: US 2025/0074364 A1
(43) Pub. Date: Mar. 6, 2025

(54) FRONT SERVICE PANEL WITH INTEGRATED WASHER FLUID RESERVOIR

(71) Applicant: Ford Global Technologies, LLC, Dearborn, MI (US)

(72) Inventors: Tobias Duffe, Köln (DE); Mirko Lehmkuhl, Ratingen (DE)

(21) Appl. No.: 18/780,817

(22) Filed: Jul. 23, 2024

(30) Foreign Application Priority Data
Aug. 30, 2023 (DE) 102023123266.5

(51) Int. Cl. B60S 1/50; B62D 21/16; B62D 25/10; B62D 25/12

(52) U.S. Cl. CPC B60S 1/50; B62D 21/16; B62D 25/105; B62D 25/12

(57) ABSTRACT

A front service panel for a motor vehicle has a lower panel structure and an upper panel covering. The lower panel structure is covered by the upper panel covering. The lower panel structure has at least one recess which forms a washer fluid reservoir. The washer fluid reservoir can be filled through an access opening in the lower panel structure.

### CROSS-REFERENCE TO RELATED APPLICATIONS

This disclosure claims priority to German Patent Application No. 102023123266.5, which was filed on 30 Aug. 2023 and is incorporated herein by reference in its entirety.

### TECHNICAL FIELD

The present disclosure generally relates to a front service panel for motor vehicles.

### BACKGROUND

Motor vehicles available at present usually have an engine hood made of steel or aluminum, which covers the engine compartment and, when lifted, permits access to the engine compartment for various purposes. For example, it permits access for maintenance purposes, be it to refill the windshield washer system, to refill and/or check the engine or air-conditioning coolant, to refill and/or check various fluid reservoirs or else to repair components of the drivetrain or other components in the area of the vehicle front.

The windscreen washer system currently comprises a separate plastic reservoir, which is accommodated in the engine compartment and is fastened to the front structure. This fastening is done, for example, by using suitable screws and fastening clamps. The plastic reservoir contains the fluid for the windshield and rear window washer and consequently has a fluid connection to the latter. To check the level of this washer fluid and to refill it, the engine hood is opened and the corresponding action is carried out on the reservoir.

In order to reduce the weight of the total motor vehicle, by now engine hoods made of plastic are known. However, these not only reduce the weight but also open up new possible ways of supplementing the engine hood with further functionalities. For example, stowage spaces like washer fluid reservoirs can be integrated.

Engine hoods made of plastic with integrated washer fluid reservoirs are known, for example from DE 10 2005 059 264 A1. As a result of this solution, the mounting of a washer fluid reservoir in the engine compartment can be dispensed with. This reduce a number of fastenings, enlarge the space in the engine compartment, makes the washer fluid reservoir more easily accessible and facilitates the assembly of the entire vehicle. Provision can be made for the washer fluid reservoir, for example, to be formed in one piece with the remainder of the engine hood. In order to fill the reservoir, a filler tube which is accessible when the engine hood is closed can also be provided, so that opening the engine hood to fill the washer fluid reservoir is not necessary.

DE 10 2015 204 791 A1 likewise discloses a filler tube for filling a washer fluid reservoir, wherein the filler tube is located at a point outside the engine hood and is accessible there. Furthermore, this filler tube is pivotable and thus can be pivoted into a filling position accessible from outside.

### SUMMARY

A front hood for a motor vehicle is shown which has a lower panel structure and an upper panel covering, wherein the lower panel structure is covered by the upper panel covering, and wherein the lower panel structure has at least one recess which forms a washer fluid reservoir, wherein the washer fluid reservoir is or can be filled through an access opening in the lower panel structure.

The following features and measures that are listed individually can be combined with one another in any desired technically expedient way, and indicate further refinements.

Motor vehicles do not necessarily have a front-side drive unit such as an internal combustion engine or other units, the original term engine hood being maintained for the front region of the motor vehicle.

In an exemplary embodiment, the front hood, i.e. the lower panel structure and the upper panel covering, consists substantially of a plastic material and is configured so as to form an engine hood of a motor vehicle but can also form only part of the engine hood, in particular a part of the engine hood that is arranged on the windshield of the motor vehicle. In the longitudinal direction of the motor vehicle, this part is then designed as a rear part of the engine hood. To this extent, the engine hood can also have a front part and/or a central part, which is arranged between the front and rear parts. However, the front hood can also be an element embodied separately from the engine hood. The plastic material is suitably selected and can be fiber-reinforced, for example. The front hood is appropriately configured in order in particular to meet the required stability and stiffness requirements even during extreme events. Other design aspects also have to be considered. Formed within the front hood is at least one washer fluid reservoir, wherein there may be still further recesses or apertures, in which devices can be accommodated or led through. To this extent, the front hood can also be designated as a front service panel.

The front hood can be formed by two longitudinal halves made of plastic, which are joined together to form the front service panel. The front service panel can have further components but the basic structure is formed by the two longitudinal halves made of plastic. The two longitudinal halves, that is to say the upper panel covering and the lower panel structure, are joined together, for example, via separate fastening means and/or securing elements. The two longitudinal halves can be nondestructively separable again manually, in order in this way to obtain access to the interior of the front service panel. For example, the two longitudinal halves can be connected to each other by one or more hinges in order to fold up the upper longitudinal half, that is to say the upper covering panel, with respect to the lower longitudinal half, that is to say the lower panel structure. The two longitudinal halves have, for example, a longitudinal extent which, when installed as in an engine hood, extends transversely with respect to a motor vehicle and form a type of elongated, flat housing for various components.

Effectively, the lower panel structure is covered by the upper panel covering, wherein the lower panel structure has at least one recess which forms the washer fluid reservoir, wherein the washer fluid reservoir is fillable, that is to say can be filled, through an access opening in the front service panel. On the inner side of the front hood, that is to say of the front service panel, the washer fluid reservoir is thus constituted as a recess within which the washer fluid is accommodated. On the outer side of the front hood, that is to say of the front service panel, the washer fluid reservoir is constituted as a bulge which projects into the front space. In this way, further functional components which are hidden by the upper panel covering and prevent the penetration of foreign bodies can also be formed in the lower panel structure, wherein the outer side of the upper panel covering in particular determines the external design of the front hood. The further functional components can be, for example, further stowage compartments, apertures and/or slots.

The washer fluid reservoir of the front hood has the advantage in particular that it does not have to be fastened with its own fastening means in the front compartment, which can also be designated as the engine compartment. Furthermore, overall space can be saved and assembly of the motor vehicle is simplified. The front hood, that is to say the front service panel, additionally does not have to be opened in order to fill the washer fluid reservoir, instead it is fillable, that is to say is to be filled, through an access opening which is arranged on the front hood. This makes the simple and clean handling easier. For this purpose, in particular a filling device can be provided, which can be designed in various ways.

In an exemplary embodiment, the lower panel structure is delimited on one long side by an elongated dividing wall, within which the access opening for filling the washer fluid reservoir is located. The dividing wall is located on the side of the windshield when the front service panel is installed, and therefore in the region of the windshield apron. Provision can be made for a closure means, with which the access opening can be covered, to be attached to the access opening for filling the washer fluid reservoir. For example, the closure means is a flap, which is pivotably attached to the dividing wall via a joint. The flap can close the front service panel flush in the region of the access opening.

The front hood, as the front service panel, preferably has the already mentioned filling device for filling the washer fluid reservoir. This is not merely an opening with a rotary cover, such as is usual in washer fluid reservoirs, instead the filling device is, for example, movable, ideally pivotable. It is in particular movable between at least two positions, wherein the filling device projects outward at least partly through the access opening in a filling position and, in this filling position, is usable for filling the washer fluid reservoir, while it is located completely within the front service panel when in a rest position. In the rest position, the filling device is thus not visible within the front hood, that is to say the front service panel, more precisely accommodated between the lower panel structure and the upper panel covering, and projects out of the front service panel only in the filling position.

In an embodiment, in the rest position of the filling device in an ideal configuration the escape of liquid out of the washer fluid reservoir through the filling device is suppressed. Washer fluid is thus prevented from getting into the environment and in particular into the windshield apron. This can be implemented by an appropriately designed blocking mechanism. For example, the filling device has a blocking mechanism which, in the activated state in the rest position of the filling device, suppresses a flow of liquid out of the washer fluid reservoir through the filling device and, in the deactivated state in the filling position of the filling device, permits a flow of liquid through the filling device in the direction of the washer fluid reservoir. In particular, the blocking mechanism is activated and deactivated automatically as the filling device is moved between the rest position and the filling position. Alternatively, the blocking mechanism is electrically controllable.

Preferably, the recess which forms the washer fluid reservoir is closed by a covering, which is arranged between the two longitudinal halves of the front hood, i.e. the front service panel. A covering, which closes an opening of the recess, is then provided in the interior of the front service panel. The filling device is then, for example, connected to the covering or is attached to the latter in such a way that washer fluid can flow through the filling device into the washer fluid reservoir, i.e. the filling device opens into the covering, in particular in an aperture arranged therein. Alternatively, the upper panel covering can have a cover element for covering the recess, wherein the cover element can be designed as an elevation on the inner side of the upper panel covering corresponding to the recess opening. The filling device then opens into the washer fluid reservoir via the cover element, preferably one of its side walls, in particular via the side wall which is oriented toward the windshield.

In another exemplary embodiment, a motor vehicle having a front hood is indicated, wherein the front hood is in particular designed according to one of the above-described embodiments or combinations of the possible configurations, wherein the washer fluid reservoir is fillable, therefore is to be filled, through the access opening. The front hood, that is to say the front service panel, is preferably arranged such that it extends along a lower edge of the windshield, and its dividing wall extends in particular along a windshield apron of the motor vehicle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

For a better understanding of the present disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 shows an embodiment of the front service panel according to an exemplary embodiment of the present disclosure in a schematic exploded illustration.

FIG. 2 shows the front service panel according to FIG. 1 in the assembled state.

FIG. 3 shows a schematic section A-A of a front service panel with integrated washer fluid reservoir.

FIG. 4 shows a section through a washer fluid reservoir having a pump.

FIG. 5 shows a three-dimensional view of a front service panel without a panel covering.

FIG. 6 shows an enlarged illustration of an embodiment of the filling device in the filling position.

FIG. 7 shows the filling operation in the filling position according to FIG. 6.

FIG. 8 (a)-(c) show a schematic illustration of the functioning of a blocking mechanism in the filling position.

FIG. 9(a)-(c) show a schematic illustration of the functioning of a blocking mechanism in the rest position.

### DETAILED DESCRIPTION

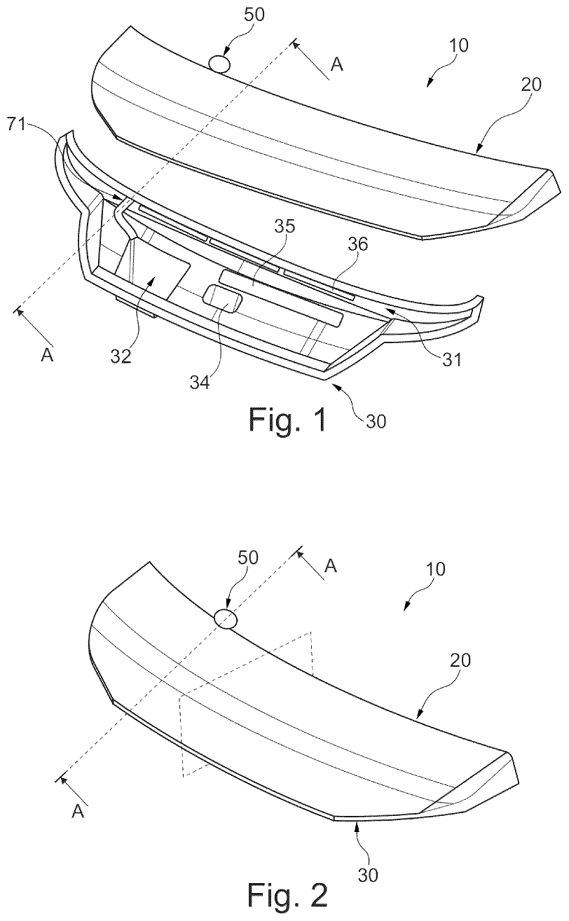

FIG. 1 shows an embodiment of a front hood, i.e. a front service panel 10, according to an exemplary aspect of the present disclosure. In the text below, the front hood will be designated as a front service panel 10 for simplicity. The front service panel 10 is designed as an engine hood for a motor vehicle (not illustrated) and has appropriate fastening means to connect the front service panel 10 to the vehicle body. In particular, the external shape and the dimensions of the front service panel 10 may vary, depending on the vehicle.

The front service panel 10 according to the configuration of FIG. 1 is designed in two parts and exhibits two longitudinal halves in a three-dimensional exploded drawing. It has a lower panel structure 30 and an upper panel covering 20 made of plastic. These two longitudinal halves are joined together to form the front service panel 10, as can be gathered from FIG. 2. The upper panel covering 20 forms the outer side of the front service panel 10 and has an appropriately attractive design, wherein penetration of foreign bodies into the front service panel 10 is also blocked by the upper panel covering 20. The lower panel structure 30 has various functional components, to which a washer fluid reservoir 32, which is formed by a recess in the lower panel structure 30, belongs.

The lower panel structure 30 is formed, for example, by a base and circumferential walls which project upward from the base and thus form a type of trough. In particular, a dividing wall 31 forms a boundary on one long side of the front service panel 10. When the front service panel 10 is installed, this dividing wall 31 runs along the windshield of a motor vehicle, is designed to be curved corresponding to the course of the windshield in the transverse direction of the motor vehicle and adjoins a windshield apron 40. The recess for forming the washer fluid reservoir 32 in this embodiment has a rectangular cross section with rounded edges and a correspondingly rectangular upper opening. A filling channel 71 of a filling device 50 is shown only schematically and will be explained in more detail further below. In addition to the recess for forming the washer fluid reservoir 32, the lower panel structure 30 has further components such as, for example, a second recess 34, which can be used as a stowage space. Additionally, provided is an aperture 35, while several slots 36 are provided in the dividing wall 31.

The upper panel covering 20 is matched to the shape of the lower panel structure 30, and they form two housing halves, which are joined together to form a resultant front service panel 10 with an internal hollow space.

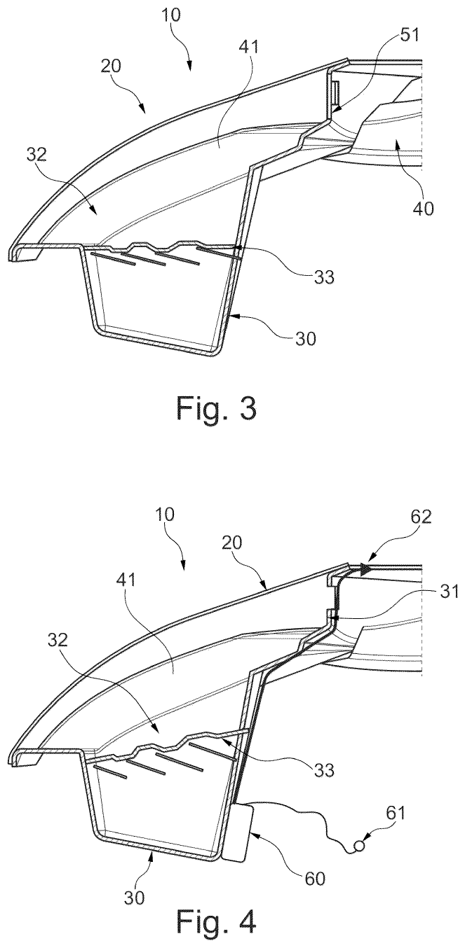

FIG. 2 shows a front service panel 10 joined together from the upper panel covering 20 and the lower panel structure 30 and having a schematically indicated filling device 50, through which a section A-A which is illustrated in FIG. 3 runs.

FIG. 3 shows the upper panel covering 20 on the lower panel structure 30 and a section through the recess (washer fluid reservoir 32) in the base of the lower panel structure 30. Washer fluid is accommodated in the washer fluid reservoir 32 up to a level or water level 33. Furthermore, the recess has a recess covering 41, not previously illustrated, which covers the upper opening of the recess. The recess covering 41 is preferably a separate component which can be separated from the lower panel structure 30. FIG. 3 further shows the dividing wall 31, which adjoins the windshield apron 40 of the motor vehicle.

To convey the washer fluid from the washer fluid reservoir 32 to a windshield wiper system, FIG. 4 shows by way of example a pump 60, which is attached to the outer side of the recess and has a power connection 61. The pump 60 is connected to the recess, in particular via a fluid opening, and is designed to convey washer fluid to a washer nozzle feed 62. This washer nozzle feed 62 runs in the region of the dividing wall 31, for example, and leads to washer fluid nozzles for spraying the adjacent windshield. Optionally, these washer nozzle feeds 62 also lead to nozzles on the rear window of the motor vehicle.

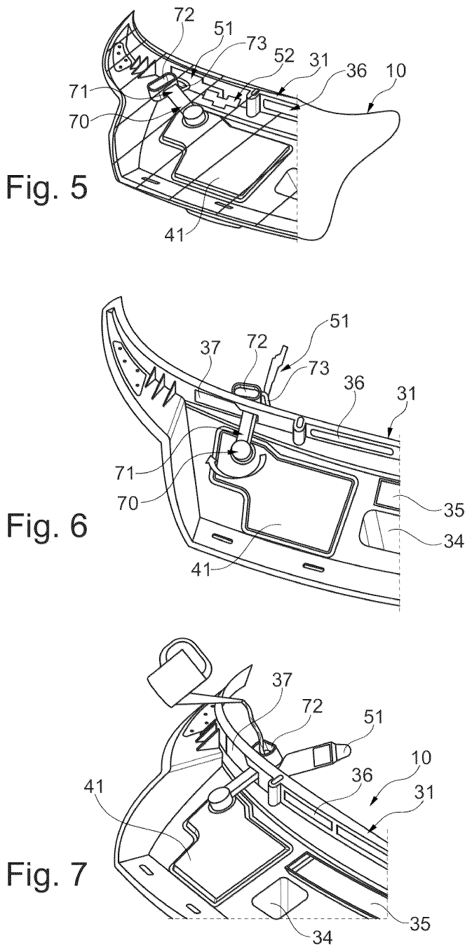

FIG. 5 shows a three-dimensional view of the front service panel 10 with an upper panel covering 20 partially omitted to permits a view into the interior of the front service panel 10. It is possible to see the covering 41 on the washer fluid reservoir and a slot 36 in the dividing wall 31. Also located in the dividing wall 31 is an access opening 37 (FIG. 6), which is closed with a closure flap 51. The flap 51 is connected to a joint/hinge 52, via which the flap 51 can be opened.

Located behind the flap 51 is the filling device 50 which, in this embodiment, is formed by a rotatable filler tube 70, a tubular filling channel 71 and a filling opening 72 at the end. The filling opening 72 is designed in the manner of a funnel, for example, and/or has at least one other boundary, which leads liquid into the filling channel 71. Also provided on the filling device 50, in particular on its filling opening 72, is an actuating handle 73, wherein the filling device 50 is designed to be pivotable and can be operated and pivoted by acting on the actuating handle 73. FIG. 5 shows the filling device 50 in a rest position behind the flap 51, in which it is located completely in the interior of the front service panel 10 and is protected against access by the closed flap 51. When the flap 51 is opened, the filling opening 72 can be pivoted over the rotatable filler tube 70 and through the access opening 37 into a filling position, which is illustrated in FIG. 6 by a rotational arrow. The filling channel 71 has a fluid connection to the washer fluid reservoir 32 via the filler tube 70 and, in the filling position, can be used for filling with washer fluid.

FIG. 6 shows the filling device 50 in a filling position, in which the flap 51 has been opened and exposes the access opening 37. The filling channel 71 is pivoted into a filling position, in which the filling opening 72 is located outside the front service panel 10. In this filling position, washer fluid can be put into the filling opening 72 and flow through the filling channel 71 and the filler tube 70 through an aperture 43 in the covering 41 into the washer fluid reservoir 32. This filling operation is shown in another three-dimensional view with an example of a filling device in FIG. 7.

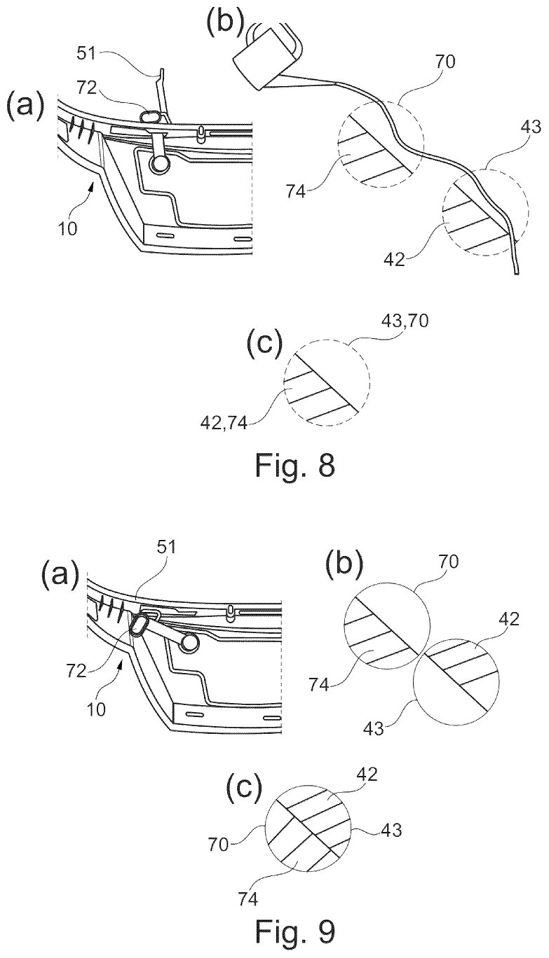

Ideally, the filling device 50 has a blocking mechanism which, in the filling position which can be seen in FIG. 7, allows the flow of a liquid through the filling channel 71 in the direction of the washer fluid reservoir 32. However, if the filling channel 71 is pivoted inward into the rest position (see FIG. 5) about an axis which extends through the filler tube 70, the blocking mechanism prevents such a flow through the filling channel 71, so that washer fluid cannot escape from the washer fluid reservoir through the filling channel 71. This blocking mechanism can be formed in various ways. In one embodiment, for example, it is formed by cross-sectional constrictions that can be rotated relative to one another within the filler tube 70 and the covering 41, as explained schematically with reference to FIGS. 8 and 9.

FIG. 8 (a) shows once more the filling position of the filling device 50. Both the covering 41 and the pivotable part of the filler tube 70 have a cross-sectional constriction. FIG. 8 (b) shows by way of example a round aperture 43 in the covering 41, the cross section of which is bisected by a stationary blocking plate 42. The round cross-section of the rotatable filler tube 70 likewise has a cross-sectional constriction in the form of a rotatable blocking plate 74. The two blocking plates 42, 74 are designed so as to correspond to each other but the respective blocking plate 42, 74 is arranged with respect to the respective other such that these lie above each other in the filling position and permit the flow through the open cross-sectional regions. The position of the blocking plates 42, 74 above each other is shown in FIG. 8 (c).

FIG. 9 (a) shows the rest position of the filling device 50, in which the rotatable blocking plate 74 of the filler tube 70 has been rotated with respect to the stationary blocking plate 42 in the aperture 43 of the covering 41 such that it closes the previous flow opening. This is shown in FIG. 9 (c), and FIG. 9 (b) indicates schematically that the flow of a liquid out of the washer fluid reservoir 32 is thus blocked.

The blocking mechanism is thus activated or deactivated automatically when the filler tube 70 is pivoted, which can be done manually by using the actuating handle 73.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A front service panel assembly for a motor vehicle, comprising:
a lower panel structure; and
an upper panel covering, the lower panel structure covered by the upper panel covering, the lower panel structure having at least one recess which forms a washer fluid reservoir that can be filled through an access opening in the lower panel structure, the upper panel covering, or both.

2. The front service panel assembly of claim 1, wherein the access opening is in the lower panel structure.

3. The front service panel assembly of claim 2, further comprising the lower panel structure is delimited on one long side by an elongated dividing wall, within which the access opening for filling the washer fluid reservoir is arranged.

4. The front service panel assembly of claim 1, further comprising a closure flap, with which the access opening can be covered, is attached to the access opening for filling the washer fluid reservoir.

5. The front service panel assembly of claim 4, wherein the closure flap is connected to the lower panel structure with a hinge.

6. The front service panel assembly of claim 1, further comprising a filling device for filling the washer fluid reservoir, the filling device movable between at least two filling positions, wherein the filling device projects outward at least partly through the access opening in a filling position and, in this filling position, can be used for filling the washer fluid reservoir, the filling device covered by the upper panel covering when located in a rest position.

7. The front service panel assembly of claim 6, wherein, in the rest position of the filling device, an escape of liquid out of the washer fluid reservoir through the filling device is suppressed.

8. The front service panel assembly of claim 7, wherein the filling device has a blocking mechanism which, in an activated state in the rest position of the filling device, suppresses a flow of liquid through the filling device and, in a deactivated state in the filling position of the filling device, permits a flow of liquid through the filling device in a direction of the washer fluid reservoir.

9. The front service panel assembly of claim 8, wherein the blocking mechanism is activated and deactivated automatically as the filling device is moved between the rest position and the filling position.

10. The front service panel assembly of claim 8, wherein the blocking mechanism comprises a plurality of blocking plates.

11. The front service panel assembly of claim 10, wherein the plurality of blocking plates comprises a rotatable blocking plate and a stationary blocking plate.

12. The front service panel assembly of claim 6, wherein the filling device is contained entirely between the lower panel structure and the upper panel covering in the rest position.

13. The front service panel assembly of claim 6, wherein the filling device is connected to the upper panel covering.

14. The front service panel assembly of claim 1, wherein the at least one recess that forms the washer fluid reservoir is closed by a recess covering.

15. The front service panel assembly of claim 1, wherein at least the upper panel covering is made of a plastic.

16. The front service panel assembly of claim 1, further comprising a pump that is configured to convey washer fluid from the washer fluid reservoir to a washer nozzle feed.

17. The front service panel assembly of claim 16, wherein the pump is attached to the lower panel structure opposite the at least one recess.

18. The front service panel assembly of claim 1, wherein the lower panel structure includes a dividing wall that provides the access opening.

19. The front service panel assembly of claim 18, wherein the dividing wall is configured to adjoin a windshield apron of a motor vehicle.
